(19) United States
(12) Patent Application Publication
(10) Pub. No.: US 2022/0354293 A1
(43) Pub. Date: Nov. 10, 2022

(54) COOKING DEVICE

(71) Applicant: FOSHAN SHUNDE MIDEA ELECTRICAL HEATING APPLIANCES MANUFACTURING CO., LTD, Foshan (CN)

(72) Inventors: Yun YANG, Foshan (CN); Zhixi CHENG, Foshan (CN); Weigang LV, Foshan (CN); Ruoyu MEI, Foshan (CN); Huaixu ZHENG, Foshan (CN); Zhaoqiang XUE, Foshan (CN); Pingying HAN, Foshan (CN)

(21) Appl. No.: 17/772,876

(22) PCT Filed: Jan. 6, 2021
(86) PCT No.: PCT/CN2021/070389

§ 371 Date: Apr. 28, 2022

(30) Foreign Application Priority Data
Jan. 7, 2020 (CN) 202010015172.1

(51) Int. Cl. A47J 27/09; A47J 27/086

(52) U.S. Cl. CPC A47J 27/09; A47J 27/086

(57) ABSTRACT

A cooking device includes an outer pot having a mounting cavity, an inner pot assembly removably arranged in the mounting cavity, a first coupler arranged at the inner pot assembly, an accommodation groove arranged at one of the inner pot assembly and the outer pot, an alignment assembly arranged at another one of the inner pot assembly and the outer pot and configured to be arranged in the accommodation groove, and a second coupler arranged at the outer pot and configured to be plugged with the first coupler.

This application claims priority to Chinese Patent Application No. 202010015172.1 filed with China National Intellectual Property Administration on Jan. 7, 2020 and entitled “Cooking Device,” the entire contents of which are incorporated herein by reference.

### FIELD

The present disclosure relates to the technical field of kitchen utensils, in particular, to a kind of cooking device.

### BACKGROUND

In the related art, in the electric pressure cooker with integrated heating tube at the bottom of the inner pot, upper and lower couplers need to be provided to realize the connection between the inner pot and the pot body to be energized. In actual use, the upper and lower couplers are often not aligned correctly. When the inner pot is put in, the upper coupler will collide with other positions of the lower coupler; the upper and lower couplers cannot be electrically connected. Further, the upper coupler hits the lower coupler, which will cause damage to the upper and lower couplers.

### SUMMARY

The present disclosure aims to solve at least one of the technical problems existing in the existing technologies or related technologies.

To this end, the first aspect of the present disclosure provides cooking device.

In view of this, according to a first aspect of the present disclosure, the present disclosure provide a cooking device, comprising an inner pot assembly; a first coupler, being arranged at the inner pot assembly; an outer pot, having a mounting cavity thereon, and the inner pot assembly being removably arranged in the mounting cavity; an alignment assembly, being arranged at one of the inner pot assembly and the outer pot; an accommodation groove, being arranged at another of the inner pot assembly and the outer pot, the alignment assembly being configured to be adapted to be arranged in the accommodation groove; and a second coupler, being arranged at the outer pot, and the second coupler being configured to be adapted to be plugged with the first coupler.

The cooking device proposed by the present disclosure comprises an inner pot assembly, a first coupler, an alignment assembly, an outer pot, an accommodation groove and a second coupler. The outer pot is provided with a mounting cavity, the inner pot assembly is removably arranged in the mounting cavity, the alignment assembly is arranged at one of the inner pot assembly and the outer pot, and the accommodation groove is arranged at another one of the inner pot assembly and the outer pot, and the alignment assembly is configured to be adapted to be arranged in the accommodation groove. The cooperation of the inner pot assembly and the outer pot is limited by setting the alignment assembly in the accommodation groove. When the alignment assembly is located in the accommodation groove, the first coupler on the inner pot assembly and the second coupler on the outer pot are plugged with each other, the cooking device can be powered on; the inner pot assembly can be accurately arranged in the outer pot. According to the cooking device provided by the present disclosure, by setting the alignment assembly on one of the inner pot assembly and the outer pot, and setting the accommodation groove on another one of the inner pot assembly and the outer pot. When the inner pot assembly is placed in the outer pot for heating, by placing the alignment assembly in the accommodation groove, the cooperation of the inner pot assembly and the outer pot can be limited. The first coupler arranged at the inner pot assembly and the second coupler arranged at the outer pot can be plugged into place. There is no need to judge whether the first coupler is plugged with the second coupler when placing the inner pot assembly, it is convenient to install the inner pot assembly into the outer pot accurately, and the user experience is improved.

According to the embodiment of the present disclosure, the cooking device may also have the following additional technical features.

In the above embodiment, furthermore, the alignment assembly comprises a handle, a plurality of handles are arranged, the accommodation groove comprises a first groove, the first groove is configured to be formed by a downward depression of an upper surface of the outer pot, and the first groove matches the handle.

In this embodiment, the alignment assembly comprises a plurality of handles, and the accommodation groove comprises a first groove that matches the handle, by placing the handle in the first groove, it is possible to limit the cooperation of the inner pot assembly and the outer pot, and the handle also serves to facilitate access to the inner pot assembly. Specifically, the handle is optionally made of a heat insulation material or a material with poor thermal conductivity, which can prevent the heat of the inner pot assembly from being transferred to the handle. By setting the handle, the inner pot assembly can be lifted directly after cooking, which reduces the waiting time for the user. Furthermore, the first groove is structured to be formed by the downward depression of the upper surface of the outer pot, which makes the first groove easy to process and improves the production efficiency of the product. Further, it is convenient for the user to lift the handle from the first groove, furthermore, set the first groove to match the handle, which makes the operation of placing the handle in the first groove simple, and simplifies the operation steps for the user to take and place the inner pot assembly. By setting the handle to match the first groove, the cooperation of the inner pot assembly and the outer pot is limited to ensure that the first coupler and the second coupler can be plugged into place quickly and accurately, to realize the normal work of the cooking device.

In any of the above embodiments, furthermore, the alignment assembly further comprises a bump, the bump is arranged at one of a bottom of the inner pot assembly and a bottom wall of the mounting cavity, the accommodation groove further comprises a second groove, the second groove is arranged at another of the bottom of the inner pot assembly and the bottom wall of the mounting cavity.

In this embodiment, the alignment assembly further comprises a bump, the accommodation groove further comprises a second groove, the cooperation of the inner pot assembly and the outer pot can be further limited by placing the bump in the second groove. By setting the bump to match the second groove, the cooperation of the inner pot assembly and the outer pot is limited, which can further ensure that the first coupler and the second coupler can be quickly and accurately plugged into place when the gap between the handle and the first groove is large, to realize the normal work of the cooking device. Specifically, the bump can be arranged at the outer bottom wall of the inner pot assembly, and the second groove can be arranged at the bottom wall of the mounting cavity; or the bump can be arranged at the bottom wall of the mounting cavity, and the second groove can be arranged at the outer bottom wall of the inner pot assembly.

In any of the above embodiments, furthermore, the alignment assembly comprises a bump being arranged at the bottom of the inner pot assembly, a plurality of bumps are arranged, the accommodation groove comprises a second groove, the second groove is arranged at the bottom wall of the mounting cavity, and the accommodation groove matches the bump.

In this embodiment, the alignment assembly comprises a plurality of bumps, and the accommodation groove comprises a second groove, the cooperation of the inner pot assembly and the outer pot can be further limited by placing the bump in the second groove. By setting the bump to match the second groove, the cooperation of the inner pot assembly and the outer pot is limited, which can ensure that the first coupler and the second coupler can be quickly and accurately plugged into place, to realize the normal work of the cooking device.

In any of the above embodiments, furthermore, the bottom wall of the outer pot comprises a stepped surface on an outer peripheral side and a sinking step in a middle portion, and a side wall of the sinking step is recessed to form the second groove; a shape of the bottom wall of the inner pot assembly matches a shape of the bottom wall of the outer pot, the inner pot assembly is embedded in the outer pot; wherein, a maximum distance between the bump and a center of the inner pot assembly is greater than a radius of the stepped surface, the bump can be supported on the stepped surface.

In this embodiment, by setting the bottom wall of the outer pot to comprise the stepped surface of the outer peripheral side and the sinking step of the middle portion, the side wall of the sinking step is recessed to form a second groove. The shape of the bottom wall of the inner pot assembly matches the shape of the bottom wall of the outer pot. The shapes of the two are similar, to ensure that the inner pot assembly is embedded inside the outer pot and to ensure that the inner pot assembly and the outer pot are used in a way that cooperates with each other.

Wherein, the maximum distance between the bump and the center of the inner pot assembly is greater than the radius of the stepped surface, the bump can be supported on the stepped surface, that is, when the first coupler and the second coupler are not aligned correctly, the alignment of the bump and the second groove is not aligned correctly. When the inner pot assembly is put into the accommodation cavity, the bump abuts on the stepped surface, the inner pot assembly cannot be put in; the first coupler and the second coupler are separated, to avoid the collision damage between the first coupler and the second coupler.

It can be understood that when the inner pot assembly is put into the outer pot, when the alignment of the first coupler and the second coupler is accurate, the bump is inserted into the second groove, the inner pot assembly is smoothly put into the outer pot, and the first coupler is inserted into the second coupler to achieve electrical connection.

In any of the above embodiments, furthermore, when the bump is located in the second groove, a radial clearance between the bump and the second groove is greater than or equal to 0.1 mm and less than or equal to 2 mm.

In this embodiment, by setting the radial clearance between the bump and the second groove to be greater than or equal to 0.1 mm and less than or equal to 2 mm, within this range, on the one hand, the radial clearance between the bump and the second groove can be prevented from being too large; the bump does not vibrate in the radial direction relative to the second groove. That is, to prevent the alignment of the first coupler and the second coupler from being inaccurate due to the radial movement of the inner pot assembly. On the other hand, it can avoid that the radial clearance between the bump and the second groove is too small, which is convenient for the inner pot assembly to be placed in the outer pot. Further, it can also prevent the bump and the second groove from being damaged due to collision during the process of placing or taking out the outer pot of the inner pot assembly, improving the durability of the cooking device.

In any of the above embodiments, furthermore, one of the first coupler and the second coupler comprises a plurality of electrode needles, another comprises a plurality of electrode grooves, when the alignment assembly is located in the accommodation groove; the electrode needle on the inner pot assembly are inserted into the electrode groove to achieve electrification.

In this embodiment, one of the first coupler and the second coupler comprises a plurality of electrode needles, and another comprises a plurality of electrode grooves. When the alignment assembly is placed in the accommodation groove, the electrode needle of the inner pot assembly is inserted into the electrode groove for energization. Therefore, it is further ensured that the first coupler and the second coupler are plugged into place, the normal work of the cooking device can be ensured through the cooperation of the second coupler and the first coupler. And by setting one of the first coupler and the second coupler to comprise a plurality of electrode needles, and another to comprise a plurality of electrode grooves, to solve the problem that the high risk of conduction between the electrodes in each circle after the ring electrodes are soaked in water when cleaning the inner pot in the related art, reducing the risk of safety accidents caused by conduction between the electrodes after cleaning the inner pot.

In any of the above embodiments, furthermore, the plurality of the electrode needles are distributed on a concentric circle, the plurality of electrode needles exist in pairs, and each pair of the electrode needles is distributed symmetrically about a center of the circle; the plurality of electrode grooves are distributed on a concentric circle, and the plurality of electrode grooves exist in pairs, and each pair of the electrode grooves is distributed symmetrically about the center of the circle; the plurality of electrode needles correspond to the plurality of electrode grooves one-to-one.

In this embodiment, a plurality of electrode needles are distributed on the concentric circle and exist in pairs, and each pair of electrode needles is distributed symmetrically about the center of the circle, the two electrode needles existing in pairs do not have to be distinguished. A plurality of electrode grooves are distributed on the concentric circle and exist in pairs, and each pair of electrode grooves is distributed symmetrically about the center of the circle, the two electrode grooves existing in pairs do not need to be distinguished. Wherein, a plurality of electrode needles corresponds to a plurality of electrode grooves one-to-one. Due to the paired and symmetrical arrangement of a plurality of electrode needles and a plurality of electrode grooves, it is not necessary to distinguish between left and right when the handle and first groove are matched. That is, the inner pot assembly can be placed in the outer pot normally or rotated 180° and placed in the outer pot, both the first coupler and the second coupler can be connected and energized, without the need for deliberate alignment, which is convenient to accurately install the inner pot assembly to the outer pot, to ensure the work of the cooking device and improve the user's control experience.

In any of the above embodiments, furthermore, based on the case that the alignment assembly comprises a handle, the number of the handles is two, and the two handles are symmetrically arranged at both sides of the inner pot assembly; or based on the case that the alignment assembly comprises a bump, the number of bumps is two, and the two bumps are distributed symmetrically about a central axis of the inner pot assembly.

In this embodiment, based on the case that the alignment assembly comprises handles, the number of handles is further limited to two, and the two handles are symmetrically arranged at both sides of the inner pot assembly. That is, two handles are symmetrically arranged at the outer side wall of the inner pot assembly, which is convenient for users to lift the inner pot assembly from both sides, and when the handle and the first groove are matched, there is no need to distinguish between left and right. That is, the inner pot assembly can be placed in the outer pot normally or rotated 180° and placed in the outer pot, both the first coupler and the second coupler can be connected and energized, without the need for deliberate alignment, which is convenient to accurately install the inner pot assembly to the outer pot, or based on the case that the alignment assembly comprises bumps, the number of bumps is further limited to two, and the two bumps are distributed symmetrically about the central axis of the inner pot assembly. That is, two bumps are symmetrically arranged along the central axis of the inner pot assembly on the bottom wall of the inner pot assembly, when the bumps and the second groove are matched, it is not necessary to distinguish between left and right. That is, the inner pot assembly is placed in the outer pot normally or rotated 180° and placed in the outer pot, which can make the bump located in the second groove, without deliberate alignment, which is convenient to accurately install the inner pot assembly to the outer pot, to ensure the work of the cooking device and improve the user's control experience.

In any of the above embodiments, furthermore, the plurality of the electrode needles are distributed on a first circle, and the plurality of electrode grooves are distributed on a second circle, and diameters of the first circle and the second circle are equal; or the plurality of electrode needles are distributed on a plurality of first circles with different diameters, the plurality of electrode grooves are distributed on the plurality of second circles with different diameters, and diameters of the plurality of first circles are equal to diameters of the plurality of second circles in one-to-one correspondence.

In this embodiment, a plurality of electrode needles are distributed on the first circle, that is, a plurality of electrode needles are distributed on the same circle, a plurality of electrode grooves are distributed on the second circle, that is, a plurality of electrode grooves are distributed on the same circle, and the diameters of the first circle and the second circle are equal. By setting the alignment assembly in the accommodation groove, the cooperation between the inner pot assembly and the outer pot can be limited. When the alignment assembly is located in the accommodation groove, the electrode needle of the first coupler on the inner pot assembly and the electrode groove of the second coupler on the outer pot can be in contact to achieve electrification. It further ensures that the inner pot is normally placed in the outer pot or rotated 180° and placed in the outer pot, that is, the first coupler and the second coupler can be connected and powered on without deliberate alignment, and the cooking device can work normally. Or a plurality of electrode needles are distributed on a plurality of first circles of different diameters. Since a plurality of electrode needles exist in pairs, it is only necessary to ensure that each pair of electrode needles is distributed on the same circle; the two electrode needles existing in pairs do not need to be distinguished. A plurality of electrode grooves are distributed on a plurality of second circles of different diameters. Since a plurality of electrode grooves exist in pairs, it is only necessary to ensure that each pair of electrode grooves is distributed on the same circle; the two electrode grooves existing in pairs do not have to be distinguished. Furthermore, the diameters of a plurality of first circles are equal to the diameters of a plurality of second circles in one-to-one correspondence, and it is possible to limit the cooperation between the inner pot assembly and the outer pot by setting the alignment assembly in the accommodation groove. When the alignment assembly is located in the accommodation groove, the electrode needle of the first coupler on the inner pot assembly and the electrode groove of the second coupler on the outer pot can be in contact to achieve electrification. It further ensures that the inner pot is normally placed in the outer pot or rotated 180° and placed in the outer pot, that is, the first coupler and the second coupler can be connected and powered on without deliberate alignment, and the cooking device can work normally.

In any of the above embodiments, furthermore, the first coupler further comprises a first ground electrode, the first ground electrode is located at a center of a distribution circle of the plurality of electrode needles; the second coupler further comprises a second ground electrode, the second ground electrode is located at a center of a distribution circle of the plurality of electrode grooves; wherein, when the first coupler is plugged with the second coupler, the first ground electrode abuts against the second ground electrode.

In this embodiment, by setting the first ground electrode on the first coupler, setting the second ground electrode on the second coupler, and setting the first ground electrode at the center of the distribution circle of a plurality of electrode needles, the second ground electrode is arranged at the center of the distribution circle of a plurality of electrode grooves. The first coupler can make the first ground electrode contact with the second ground electrode no matter which direction the first coupler is inserted into the second coupler. That is, by placing the handle in the accommodation groove, the first ground electrode and the second ground electrode can be abutted without deliberate alignment, which further ensures that the first coupler and the second coupler are plugged into place, and by setting the first ground electrode and the second ground electrode, can improve the safety of the use of the cooking device.

In any of the above embodiments, furthermore, a distance between a groove wall of the first groove and an edge of the handle ranges from 0.2 mm to 6 mm.

In this embodiment, by setting the distance between the groove wall of the first groove and the edge of the handle, the value ranges from 0.2 mm to 6 mm, within this range, on the one hand, the distance between the groove wall of the first groove and the edge of the handle can be prevented from being too large, which ensures that when the handle is placed in the first groove, the handle does not shake relative to the first groove. That is, to prevent the misalignment of the first coupler and the second coupler due to the circumferential rotation of the inner pot assembly.

On the other hand, it can also avoid that the distance between the groove wall of the first groove and the edge of the handle is too small, which can prevent the handle and the first groove from being worn due to collision when the handle is placed in the first groove, improving the service life of the cooking device.

In any of the above embodiments, furthermore, a distance between a side wall of the inner pot assembly and an inner side wall of the mounting cavity ranges from 0.1 mm to 6 mm.

In this embodiment, by setting the distance between the side wall of the inner pot assembly and the inner side wall of the mounting cavity, the value ranges from 0.1 mm to 6 mm, within this range, on the one hand, the distance between the side wall of the inner pot assembly and the inner side wall of the mounting cavity can be avoided from being too large, which ensures that the inner pot assembly does not shake relative to the outer pot, that is, prevents the alignment of the first coupler and the second coupler from being inaccurate due to the radial movement of the inner pot. On the other hand, it can be avoided that the distance between the side wall of the inner pot assembly and the inner side wall of the mounting cavity is too small, it can also prevent the inner pot assembly and the mounting cavity from being damaged due to collision during the process of placing or taking out the outer pot of the inner pot assembly, improving the durability of the cooking device.

In any of the above embodiments, furthermore, the cooking device further comprises: a mounting structure, being arranged at a bottom wall of the outer pot, the second coupler being located at the mounting structure, the mounting structure being configured to be adapted to support the second coupler.

In this embodiment, the outer pot is provided with a mounting structure, the second coupler is located at the mounting structure and the mounting structure can support the second coupler, which can limit, fix and support the assembly of the second coupler, which can ensure the installation position of the second coupler. Therefore, the assembly of the second coupler is simple, and the first coupler and the second coupler are ensured to be plugged in place, the internal structure of the cooking device is arranged in an orderly manner, and there will be no structural interference, and avoid the downward displacement of the second coupler when it is subjected to the impact force of the inner pot pressing downward.

Furthermore, the mounting structure can be a one-piece structure formed integrally with the outer pot. The one-piece structure has good mechanical properties, so it can improve the connection strength between the outer pot and the mounting structure. In addition, the outer pot and the mounting structure can be made into one piece and mass-produced to improve the processing efficiency of the product and reduce the processing cost of the product. And by designing the outer pot and the mounting structure into an integrated structure, the integrity of the cooking device is improved, the number of parts and components is reduced, the installation process is reduced, the installation efficiency is improved, and the installation of the cooking device is more convenient and reliable.

In any of the above embodiments, furthermore, the mounting structure comprises: a mounting hole, being arranged at a bottom wall of the outer pot; a rib, being arranged at an outer periphery of the mounting hole, the rib being protrudingly arranged at a bottom wall of the outer pot, and the rib supporting the second coupler; and a positioning boss, being protrudingly arranged at the rib.

In this embodiment, the bottom wall of the outer pot is provided with a mounting hole, a rib is arranged at the outer periphery of the mounting hole, the rib is protrudingly arranged at the bottom wall of the outer pot, and the rib can support the second coupler. Therefore, the second coupler is fixed on the outer pot through the rib, the rib has a simple structure and is easy to produce, which can simplify the production process of the outer pot and improve the production efficiency. Furthermore, the height of the rib can be 0.5 mm to 5 mm, within this range, the height of the rib is suitable, which is convenient for the processing and production of the rib and the outer pot, and ensures that the rib can support the installation of the second coupler.

In addition, the rib is provided with a positioning boss, which can effectively prevent the second coupler from rotating on the outer pot, and ensure the stable installation of the second coupler. Furthermore, the height of the positioning boss can be 1 mm to 10 mm, within this range, the height of the positioning boss is suitable, which is convenient for the processing and production of the positioning boss and the outer pot, and improves the production efficiency.

In any of the above embodiments, furthermore, the second coupler comprises: a coupler housing; a buckle, being arranged at the coupler housing, and the buckle being buckled on an outside of the bottom wall of the outer pot through the mounting hole; and a support member, being arranged at an outer periphery wall of the coupler housing, the support member abutting against the rib, and a notch extending through the support member along an axial direction of the second coupler being arranged at the support member, and the positioning boss being located in the notch.

In this embodiment, the second coupler comprises a coupler housing, a buckle and a support member, the buckle is arranged at the coupler housing, and when the second coupler is arranged, the buckle passes through the mounting hole arranged at the bottom wall of the outer pot from the inside of the mounting cavity, and is buckled outside the bottom wall of the outer pot. That is, the second coupler is arranged at the outer pot from top to bottom, which facilitates the installation of the second coupler. Furthermore, a support member is arranged at the outer periphery wall of the coupler housing, and the support member abuts against the rib. That is, the rib is located under the support member to support the support member, and then the rib is sandwiched between the support member and the buckle of the second coupler, the installation of the second coupler is realized through the cooperation between the support member and the buckle and the rib.

In addition, the support member is provided with a notch extending through the support member along the axial direction of the second coupler, and the rib is provided with a positioning boss. When the second coupler is assembled on the outer pot, the positioning boss is located in the notch, which prevents the second coupler from rotating on the outer pot, and ensures the stable installation of the second coupler.

Furthermore, the height of the support member can be 1 mm to 10 mm, within this range, the height of the support member is suitable, which not only facilitates the processing and production of the support member and the coupler housing, but also ensures that the support member has sufficient strength, it can withstand the pressure of the inner pot on the second coupler and is not easy to break and damage, it cooperates with the rib to support the second coupler.

In any of the above embodiments, furthermore, the inner pot assembly comprises: an inner pot; a heating element, being arranged at a bottom wall of the inner pot; and a bottom cover, being arranged at a bottom of the inner pot, and connected with the inner pot, wherein, the bump is arranged at the bottom cover, the bottom wall and the bottom cover of the inner pot together form a sealed cavity, the heating element is arranged in the sealed cavity, and electrically connected with the first coupler, and the first coupler is located at least partially inside the sealed cavity.

In this embodiment, the bottom cover is arranged at the bottom of the inner pot, the bottom wall and the bottom cover of the inner pot are enclosed into a sealed cavity. The bump is arranged at the bottom cover to facilitate the processing of the bump, the heating element is arranged in the sealed cavity, and the heating element is electrically connected with the first coupler. During the use of the inner pot, the first coupler is used in a way that cooperates with the second coupler to supply power to the heating element, and the heating element works to generate heat to cook the food in the cooking cavity. A part of the structure of the first coupler is located in the sealed cavity, and the electrical components of the inner pot are also located in the sealed cavity.

In any of the above embodiments, furthermore, the inner pot comprises: a pot body; a bottom plate, being arranged between the pot body and the heating element, and the heating element and the first coupler being respectively connected with the bottom plate.

In this embodiment, a bottom plate is arranged between the pot body and the heating element, and both the heating element and the first coupler are arranged at the bottom plate. On the one hand, the bottom plate can prevent the heating element and the first coupler from being directly connected to the pot body, avoid the damage to the pot body caused by the connection process of the heating element and the first coupler, and reduce the difficulty of connecting the heating element and the first coupler. On the other hand, the bottom plate can avoid the direct contact between the heating element and the pot body, the heat generated by the heating element is transferred to the pot body through the bottom plate, to ensure that the bottom of the pot body is evenly heated and the cooking effect is ensured.

Specifically, the pot body is made of stainless steel inner pot, and the bottom plate is made of aluminum bottom plate. The bottom plate is fixed on the pot body by welding or screws; the first coupler is fixed on the bottom plate by screws.

In any of the above embodiments, furthermore, the cooking device further comprises: a sensor, being arranged at the inner pot; and a pressure plate, being arranged at the first coupler, the pressure plate being configured to be adapted to fix the sensor.

In this embodiment, the sensor is arranged at the inner pot, the pressure plate is arranged at the first coupler, and is configured to be adapted to fix sensor. Specifically, the sensor can be a temperature sensor, and pressure is applied to the sensor through a pressure plate, the sensor and the inner pot assembly fit together, which can ensure that the sensor and the inner pot assembly are in firm contact and fit tightly. This ensures that the temperature of the medium inside the inner pot assembly can be quickly and accurately transferred to the sensor; the sensor can accurately measure the temperature and improve the performance of the product.

In any of the above embodiments, furthermore, the cooking device further comprises: a fixation column, being arranged at the bottom plate, and extending downward from a bottom wall of the bottom plate; a fixation hole, being arranged at the first coupler, and the fixation column being inserted into the fixation hole; and a connection member, being connected with the fixation column through the fixation hole to connect the first coupler and the bottom plate.

In this embodiment, the bottom plate is provided with a fixation column extending downward from the bottom wall of the bottom plate. The first coupler is provided with a fixation hole, the fixation column is inserted into the fixation hole, and the connection member is connected to the fixation column through the fixation hole. Therefore, the first coupler is fixed on the bottom plate through the connection member, which can not only make the connection between the first coupler and the bottom plate firm, but also facilitate the installation and disassembly of the first coupler.

In the description of the present disclosure, it should be noted that the “cooking device” mentioned in the present disclosure can comprise any cooking device capable of cooking food to which the embodiment of the present disclosure can be applied, comprising but not limited to pressure cookers and rice cookers.

Additional aspects and advantages of the present disclosure will become apparent in the following description, or are understood by the practice of the present disclosure.

### BRIEF DESCRIPTION OF THE DRAWINGS

The above and/or additional aspects and advantages of the present disclosure will become apparent and readily understood from the following description of embodiments in conjunction with the drawings.

FIG. 1 shows a schematic structural diagram of a cooking device according to an embodiment of the present disclosure.

FIG. 2 shows a partial enlarged view of a cooking device at A of the embodiment shown in FIG. 1.

FIG. 3 shows another schematic structural diagram of a cooking device according to an embodiment of the present disclosure.

FIG. 4 shows a partial enlarged view of a cooking device at B of the embodiment shown in FIG. 3.

FIG. 5 shows a schematic structural diagram of an outer pot of a cooking device according to an embodiment of the present disclosure.

FIG. 6 shows a schematic structural diagram of an inner pot assembly of a cooking device according to an embodiment of the present disclosure.

FIG. 7 shows another schematic structural diagram of an outer pot of a cooking device according to an embodiment of the present disclosure.

FIG. 8 shows a partial enlarged view of a cooking device at C of the embodiment shown in FIG. 7.

FIG. 9 shows a schematic structural diagram of a second coupler of a cooking device according to an embodiment of the present disclosure.

FIG. 10 shows an exploded view of a cooking device according to an embodiment of the present disclosure.

FIG. 11 shows a schematic diagram of a partial structure of a cooking device according to an embodiment of the present disclosure.

FIG. 12 shows a schematic structural diagram of an outer pot of a cooking device according to another embodiment of the present disclosure.

FIG. 13 shows a schematic structural diagram of an inner pot assembly of a cooking device according to another embodiment of the present disclosure.

FIG. 14 shows a partial exploded view of a cooking device according to another embodiment of the present disclosure.

FIG. 15 shows yet another partial exploded view of a cooking device according to another embodiment of the present disclosure.

FIG. 16 shows a schematic structural diagram of a cooking device according to another embodiment of the present disclosure.

FIG. 17 shows a partial enlarged view of a cooking device at D of the embodiment shown in FIG. 16.

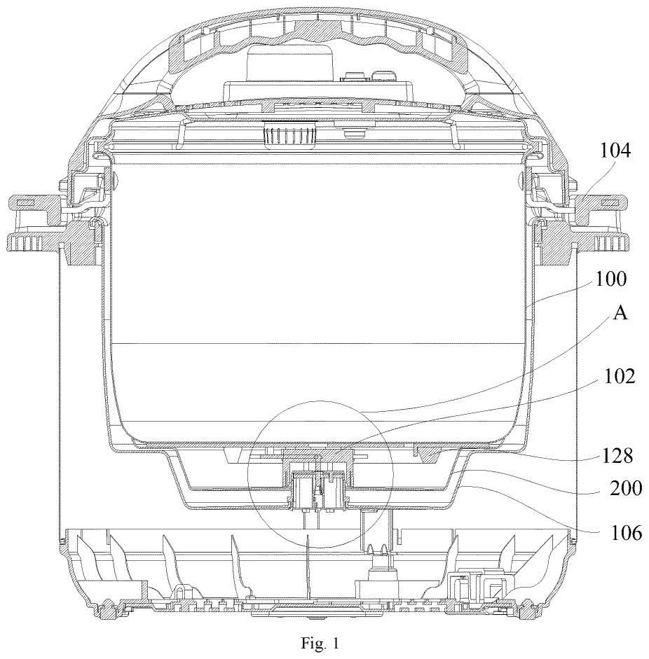

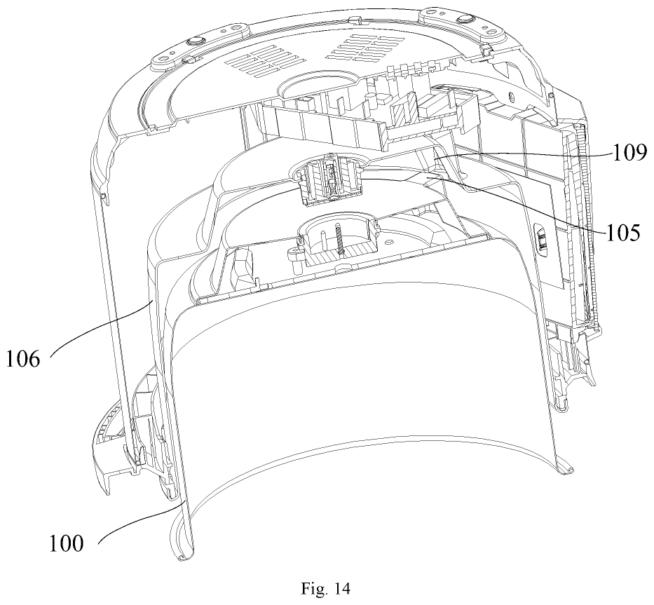

The corresponding relationship between the reference signs and component names in FIGS. 1-17 is as follows:

100 inner pot assembly, 102 first coupler, 104 handle, 105 bump, 106 outer pot, 107 stepped surface, 108 first groove, 109 second groove, 110 second coupler, 112 electrode needle (1121 electrode needle A, 1122 electrode needle B, 1123 electrode needle C, 1124 electrode needle D), 114 electrode groove (1141 electrode groove a, 1142 electrode groove b, 1143 electrode groove c, 1144 electrode groove d), 116 first ground electrode, 118 second ground electrode, 120 rib, 122 positioning boss, 124 buckle, 126 support member, 128 heating element, 200 bottom cover, 202 bottom plate, 204 sensor, 206 fixation column, 208 fixation hole, 226 mounting hole, 228 mounting structure, 230 coupler housing, 232 notch.

### DETAILED DESCRIPTION OF THE EMBODIMENTS

In order that the above-mentioned objectives, features and advantages of the present disclosure can be understood more clearly, a further detailed description of the present disclosure will be given below in connection with the accompanying drawings and specific embodiments. It should be noted that the embodiments of the present disclosure and the features in the embodiments can be combined with each other if there is no conflict.

In the following description, numerous specific details are set forth in order to provide a thorough understanding of the present disclosure. However, the present disclosure can also be implemented in other manners than those described herein. Therefore, the protection scope of the present disclosure is not limited to the specific embodiments disclosed below.

A cooking device according to some embodiments of the present disclosure is described below with reference to FIGS. 1 to 17.

### Embodiment 1

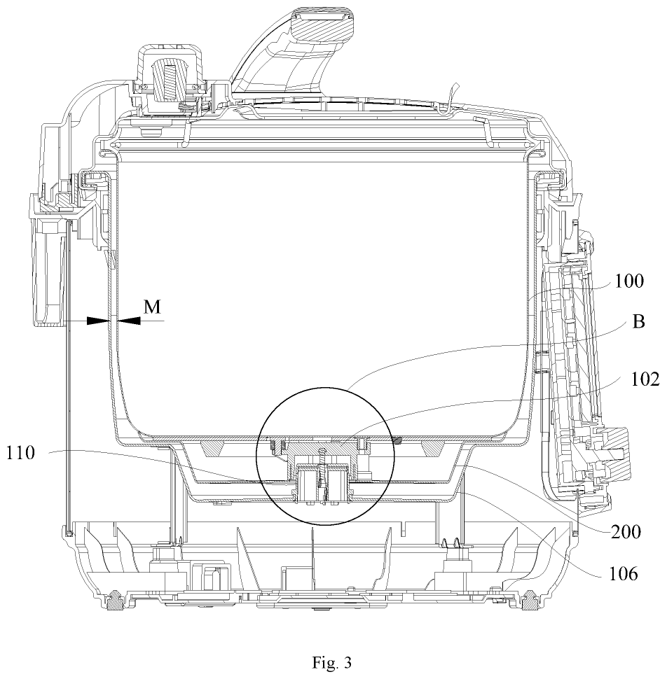

As shown in FIGS. 1 and 3, according to the first aspect of the present disclosure, the present disclosure provides a cooking device comprises an inner pot assembly 100, a first coupler 102, an alignment assembly, an outer pot 106, an accommodation groove and a second coupler 110.

Specifically, the outer pot 106 is provided with a mounting cavity, the inner pot assembly 110 is removably arranged in the mounting cavity, the alignment assembly is arranged at one of the inner pot assembly 100 and the outer pot 106, and the accommodation groove is arranged at another one of the inner pot assembly 110 and the outer pot 106, and the alignment assembly is configured to be adapted to be arranged in the accommodation groove. The cooperation of the inner pot assembly 110 and the outer pot 106 is limited by setting the alignment assembly in the accommodation groove. When the alignment assembly is located in the accommodation groove, the first coupler 102 on the inner pot assembly 100 and the second coupler 110 on the outer pot 106 are plugged with each other, the cooking device can be powered on; the inner pot assembly 100 can be accurately arranged in the outer pot 106. According to the cooking device provided by the present disclosure, by setting the alignment assembly on one of the inner pot assembly 100 and the outer pot 106, and setting the accommodation groove on another one of the inner pot assembly and the outer pot. When the inner pot assembly 100 is placed in the outer pot 106 for heating, by placing the alignment assembly in the accommodation groove, the cooperation of the inner pot assembly 100 and the outer pot 106 can be limited. The first coupler 102 arranged at the inner pot assembly 100 and the second coupler 110 arranged at the outer pot 106 can be plugged into place. There is no need to judge whether the first coupler 102 is plugged with the second coupler 110 when placing the inner pot assembly 100, it is convenient to install the inner pot assembly 100 into the outer pot 106 accurately, and the user experience is improved.

### Embodiment 2

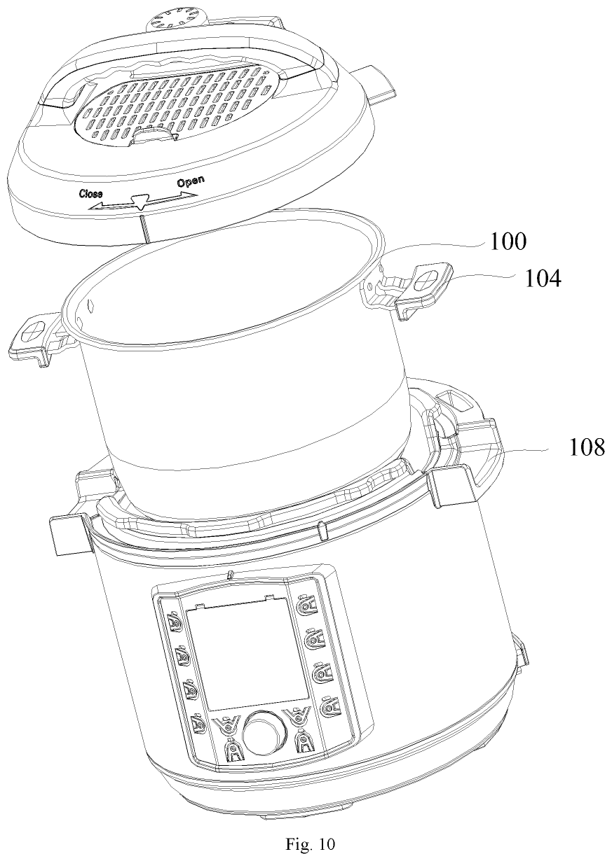

As shown in FIGS. 1 and 10, in a specific embodiment of the present disclosure, furthermore, the alignment assembly comprises two handles 104, the accommodation groove comprises a first groove 108 matching the handle 104, and the two handles 104 are symmetrically arranged at both sides of the inner pot assembly 100, that is, by placing the handle 104 in the first groove 108, it is possible to limit the cooperation of the inner pot assembly 100 and the outer pot 106, and the handle 104 also serves to facilitate access to the inner pot assembly 100. Specifically, the handle 104 is optionally made of a heat insulation material or a material with poor thermal conductivity, which can prevent the heat of the inner pot assembly 100 from being transferred to the handle. By setting the handle 104, the inner pot assembly 100 can be lifted directly after cooking, which reduces the waiting time for the user. Furthermore, the first groove 108 is structured to be formed by the downward depression of the upper surface of the outer pot 106, which makes the first groove 108 easy to process and improves the production efficiency of the product. Further, it is convenient for the user to lift the handle 104 from the first groove 108, furthermore, set the first groove 108 to match the handle 104, which makes the operation of placing the handle 104 in the first groove 108 simple, and simplifies the operation steps for the user to take and place the inner pot assembly 100. By setting the handle 104 to match the first groove 108, the cooperation of the inner pot assembly 100 and the outer pot 106 is limited to ensure that the first coupler 102 and the second coupler 110 can be plugged into place quickly and accurately, to realize the normal work of the cooking device.

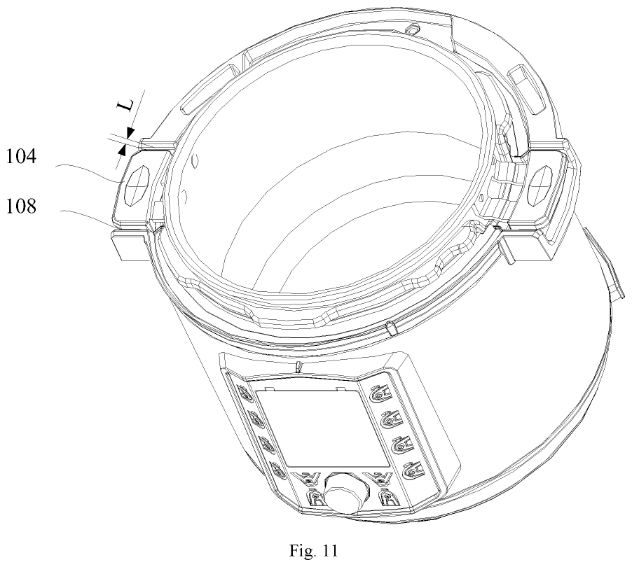

As shown in FIG. 11, in any one of the above-mentioned embodiments, furthermore, by setting the distance between the groove wall of the first groove 108 and the edge of the handle 104 is L, the value of the distance L ranges from 0.2 mm to 6 mm. within this range, on the one hand, the distance between the groove wall of the first groove 108 and the edge of the handle 104 can be prevented from being too large, which ensures that when the handle 104 is placed in the first groove 108, the handle 104 does not shake relative to the first groove 108. That is, to prevent the misalignment of the first coupler 102 and the second coupler 110 due to the circumferential rotation of the inner pot assembly. On the other hand, it can also avoid that the distance between the groove wall of the first groove 108 and the edge of the handle 104 is too small, which can prevent the handle 104 and the first groove 108 from being worn due to collision when the handle 104 is placed in the first groove 108, improving the service life of the cooking device.

### Embodiment 3

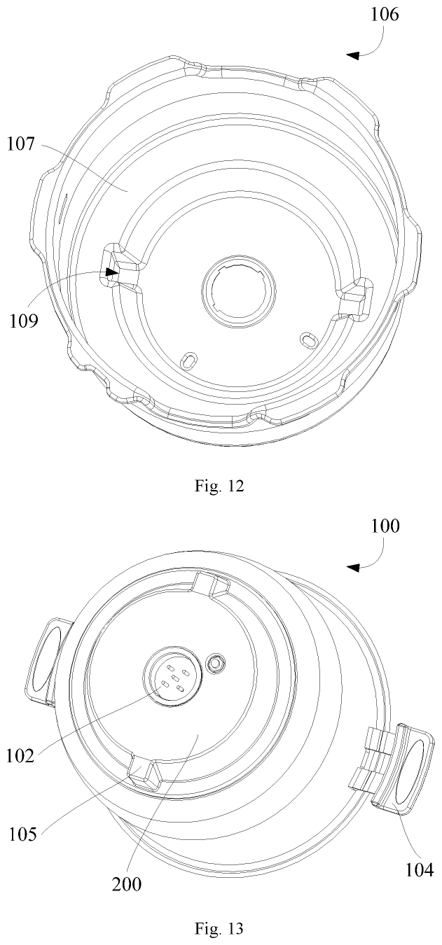

On the basis of the above-mentioned embodiment 2, furthermore, as shown in FIGS. 12, 13 and 14, the alignment assembly further comprises a bump 105, the bump 105 is arranged at one of a bottom of the inner pot assembly 100 and a bottom wall of the mounting cavity, the accommodation groove further comprises a second groove 109, the second groove 109 is arranged at another of the bottom of the inner pot assembly 100 and the bottom wall of the mounting cavity.

In this embodiment, the alignment assembly further comprises a bump 105, the accommodation groove further comprises a second groove 109, the cooperation of the inner pot assembly 100 and the outer pot 106 can be further limited by placing the bump 105 in the second groove 109. By setting the bump 105 to match the second groove 109, the cooperation of the inner pot assembly 100 and the outer pot 106 is limited, which can further ensure that the first coupler 102 and the second coupler 110 can be quickly and accurately plugged into place when the gap between the handle 104 and the first groove 108 is large, to realize the normal work of the cooking device. Specifically, the bump 105 can be arranged at the outer bottom wall of the inner pot assembly 100, and the second groove 109 can be arranged at the bottom wall of the mounting cavity; or the bump 105 can be arranged at the bottom wall of the mounting cavity, and the second groove 109 can be arranged at the outer bottom wall of the inner pot assembly 100.

### Embodiment 4

As shown in FIGS. 12 and 17, in a specific embodiment of the present disclosure, furthermore, the alignment assembly comprises a bump 105, which is arranged at the bottom of the inner pot assembly 100, the number of bump 105 is two, and the two bump 105 are distributed symmetrically about the central axis of the inner pot assembly 100; the accommodation groove comprises a second groove 109, the second groove 109 is arranged at the bottom wall of the mounting cavity, the accommodation groove matches the bump 105.

In this embodiment, as shown in FIGS. 12, 13 and 14, the alignment assembly comprises a bump 105, and the accommodation groove comprises a second groove 109, by placing bump 105 in the second groove 109, the cooperation between the inner pot assembly 100 and outer pot 106 can be limited. By setting the bump 105 to match the second groove 109, the cooperation of the inner pot assembly 100 and the outer pot 106 is limited, which can ensure that the first coupler 102 and the second coupler 110 can be quickly and accurately plugged into place, to realize the normal work of the cooking device. Specifically, the number of bumps 105 is two, and the two bumps 105 are distributed symmetrically about the central axis of the inner pot assembly 100. That is, two bumps 105 are symmetrically arranged along the central axis of the inner pot assembly 100 on the bottom wall of the inner pot assembly 100, when the bumps 105 and the second groove 109 are matched, it is not necessary to distinguish between left and right. That is, the inner pot assembly 100 is placed in the outer pot 106 normally or rotated 180° and placed in the outer pot 106, which can make the bump 105 located in the second groove 109, without deliberate alignment, which is convenient to accurately install the inner pot assembly 100 to the outer pot 106, to ensure the work of the cooking device and improve the user's control experience.

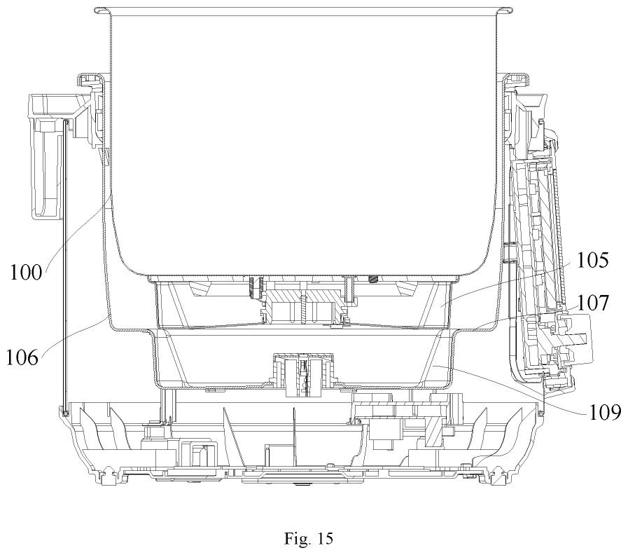

On the basis of above-mentioned embodiments 3 and 4, furthermore, as shown in FIGS. 12 and 15, by setting the bottom wall of the outer pot 106 to comprise the stepped surface 107 of the outer peripheral side and the sinking step of the middle portion, the side wall of the sinking step is recessed to form a second groove 109. The shape of the bottom wall of the inner pot assembly 100 matches the shape of the bottom wall of the outer pot 106. The shapes of the two are similar, to ensure that the inner pot assembly 100 is embedded inside the outer pot 106 and to ensure that the inner pot assembly 100 and the outer pot 106 are used in a way that cooperates with each other. Wherein, the maximum distance between the bump 105 and the center of the inner pot assembly 100 is greater than the radius of the stepped surface 107, the bump 105 can be supported on the stepped surface 107, that is, when the first coupler 102 and the second coupler 110 are not aligned correctly, the alignment of the bump 105 and the second groove 109 is not aligned correctly. When the inner pot assembly 100 is put into the accommodation cavity, the bump 105 abuts on the stepped surface 107, the inner pot assembly 100 cannot be put in; the first coupler 102 and the second coupler 110 are separated, to avoid the collision damage between the first coupler 102 and the second coupler 110.

It can be understood that when the inner pot assembly 100 is put into the outer pot 106, when the alignment of the first coupler 102 and the second coupler 110 is accurate, the bump 105 is inserted into the second groove 109, the inner pot assembly 100 is smoothly put into the outer pot 106, and the first coupler 102 is inserted into the second coupler 110 to achieve electrical connection.

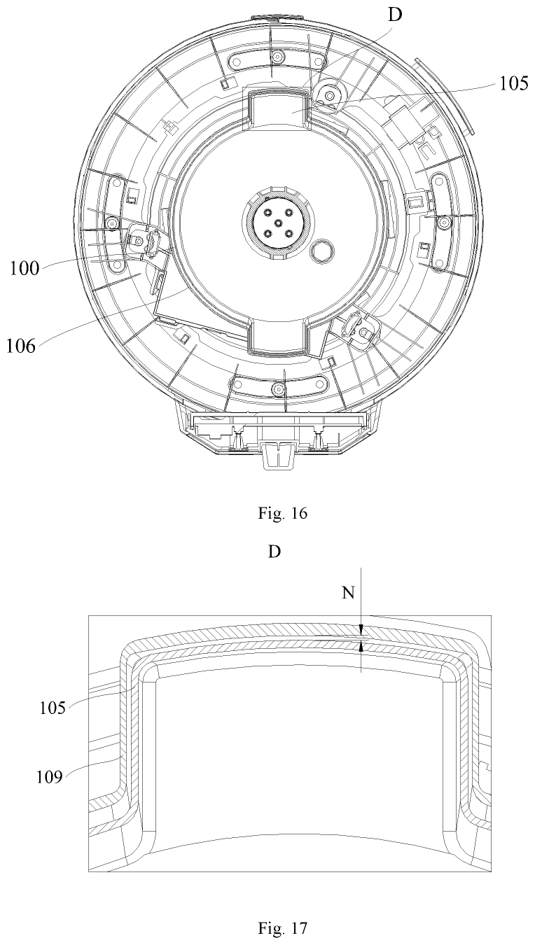

On the basis of above-mentioned embodiments 3 and 4, furthermore, as shown in FIGS. 16 and 17, by setting the radial clearance N between the bump 105 and the second groove 109 to be greater than or equal to 0.1 mm and less than or equal to 2 mm, within this range, on the one hand, the radial clearance N between the bump 105 and the second groove 109 can be prevented from being too large, the bump 105 does not vibrate in the radial direction relative to the second groove 109. That is, to prevent the alignment of the first coupler 102 and the second 110 coupler from being inaccurate due to the radial movement of the inner pot assembly 100. On the other hand, it can avoid that the radial clearance N between the bump 105 and the second groove 109 is too small, which is convenient for the inner pot assembly 100 to be placed in the outer pot 106. Further, it can also prevent the bump 105 and the second groove 109 from being damaged due to collision during the process of placing or taking out the outer pot 106 of the inner pot assembly 100, improving the durability of the cooking device.

As shown in FIG. 3, on the basis of any one of the above-mentioned embodiments, furthermore, by setting the distance between the side wall of the inner pot assembly 100 and the inner side wall of the mounting cavity is M, the value of M ranges from 0.1 mm to 6 mm, within this range, on the one hand, the distance between the side wall of the inner pot assembly 100 and the inner side wall of the mounting cavity can be avoided from being too large, which ensures that the inner pot assembly 100 does not shake relative to the outer pot 106, that is, prevents the alignment of the first coupler 102 and the second coupler 110 from being inaccurate due to the radial movement of the inner pot assembly 100. On the other hand, it can be avoided that the distance between the side wall of the inner pot assembly 100 and the inner side wall of the mounting cavity is too small, it can also prevent the inner pot assembly 100 and the mounting cavity from being damaged due to collision during the process of placing or taking out the outer pot 106 of the inner pot assembly 100, improving the durability of the cooking device.

### Embodiment 5

In any one of the above-mentioned embodiments, furthermore, one of the first coupler 102 and the second coupler 110 comprises a plurality of electrode needles 112, and another comprises a plurality of electrode grooves 114. When the alignment assembly is placed in the accommodation groove, the electrode needle 112 of the inner pot assembly 100 is inserted into the electrode groove 114 for energization. Therefore, it is further ensured that the first coupler 102 and the second coupler 110 are plugged into place, the normal work of the cooking device can be ensured through the cooperation of the second coupler 110 and the first coupler 102.

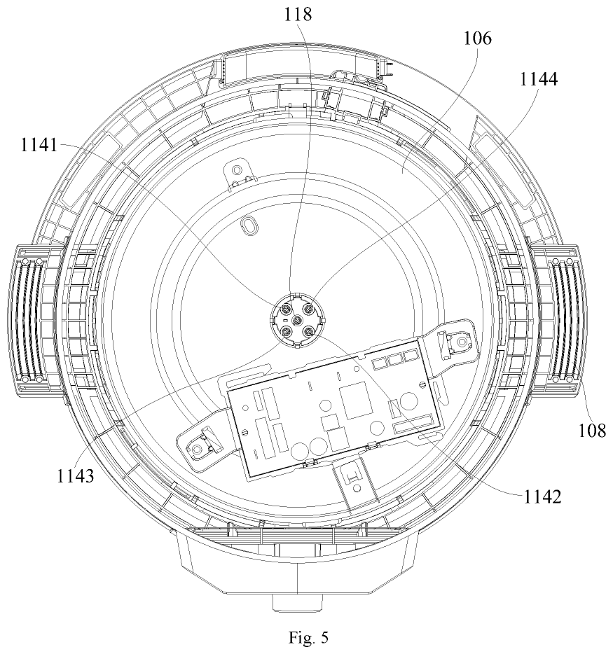

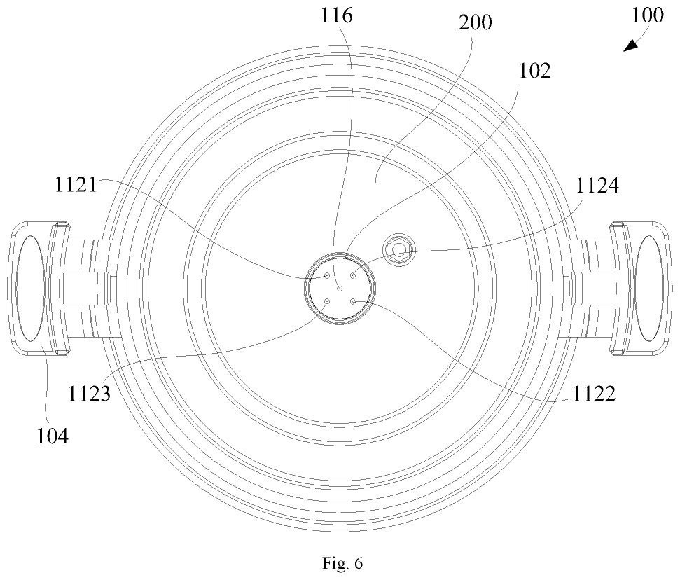

As shown in FIGS. 5 and 6, in any one of the above-mentioned embodiments, furthermore, a plurality of electrode needles 112 are distributed on the concentric circle and exist in pairs, and each pair of electrode needles 112 is distributed symmetrically about the center of the circle, the two electrode needles 112 existing in pairs do not have to be distinguished. A plurality of electrode grooves 114 are distributed on the concentric circle and exist in pairs, and each pair of electrode grooves 114 is distributed symmetrically about the center of the circle, the two electrode grooves 114 existing in pairs do not need to be distinguished. Wherein, a plurality of electrode needles 112 corresponds to a plurality of electrode grooves 114 one-to-one. Due to the paired and symmetrical arrangement of a plurality of electrode needles 112 and a plurality of electrode grooves 114, it is not necessary to distinguish between left and right when the handle 104 and first groove are matched. That is, the inner pot assembly 100 can be placed in the outer pot 106 normally or rotated 180° and placed in the outer pot 106, both the first coupler 102 and the second coupler 100 can be connected and energized, without the need for deliberate alignment, which is convenient to accurately install the inner pot assembly 100 to the outer pot 106, to ensure the work of the cooking device and improve the user's control experience.

As shown in FIGS. 5 and 6, in a specific embodiment, furthermore, the first coupler 102 can be provided with five electrode needle 112, that is, an electrode needle A1121, an electrode needle B1122, an electrode needle C1123, an electrode needle D1124, and a first ground electrode 116, correspondingly, the second coupler 110 can be provided with five electrode grooves 114, that is, an electrode groove a1141, an electrode groove b1142, an electrode groove c1143, an electrode groove d1144, and a second ground electrode 118.

Specifically, when the user puts the inner pot assembly 100 into the outer pot 106 in one direction, the accommodation groove limits the alignment assembly (i.e. the handle 104), the inner pot assembly 100 moves down, the first coupler 102 contacts the second coupler 110, and the electrode needle 112 is inserted into the electrode groove 114. At this time, the electrode needle A1121 matches the electrode groove a1141 (or the electrode needle A1121 matches the electrode groove b1142), the electrode needle B1122 matches the electrode groove b1142 (or the electrode needle B 1122 matches the electrode groove a1141), and the electrode needle C1123 matches the electrode groove c1143 (or the electrode needle C1123 matches the electrode groove d1144), the electrode needle D1124 matches the electrode groove d1144 (or the electrode needle D1124 matches the electrode groove c1143), the first ground electrode 116 matches the second ground electrode 118, to achieve normal electrification.

When the user puts the inner pot assembly 100 into the outer pot 106 in another direction (the above-mentioned direction is rotated 180°), the accommodation groove limits the alignment assembly (i.e. the handle 104), the inner pot assembly 100 moves down, and the first coupler 102 contacts the second coupler 110, the electrode needle 112 is inserted into the electrode groove 114. At this time, the electrode needle A1121 matches the electrode groove b1142 (or the electrode needle A1121 matches the electrode groove a1141), the electrode needle B1122 matches the electrode groove a1141 (or the electrode needle B1122 matches the electrode groove b1142), and the electrode needle C1123 matches the electrode groove d1144 (or the electrode needle C1123 matches the electrode groove c1143), the electrode needle D1124 matches the electrode groove c1143 (or the electrode needle D1124 matches the electrode groove d1144), the first ground electrode 116 matches the second ground electrode 118, to achieve normal electrification. The user aligns the inner pot assembly 100, puts the alignment assembly (i.e. the handle) into the accommodation groove, without distinguishing between left and right, without deliberately aligning, the first coupler 102 and the second coupler 110 can be connected and powered up, improving the control experience.

On the basis of the above-mentioned specific embodiment, the first coupler 102 can also be set to comprise four electrode needles 112, that is, the electrode needle A1121, the electrode needle B1122, the electrode needle C1123, and the electrode needle D1124. Correspondingly, the second coupler 110 is also provided with four electrode grooves 114, that is, the electrode groove a1141, the electrode groove b1142, the electrode groove c1143, and the electrode groove d1144. That is, the first coupler 102 and the second coupler 110 are not provided with ground electrodes, the user can also put the inner pot assembly 100 into the outer pot 106 in two directions, the accommodation groove limits the alignment assembly (i.e. the handle 104), the inner pot assembly 100 moves down. The way of plugging each electrode (except the ground electrode) of the first coupler 102 and the second coupler 110 is the same as that of the above-mentioned specific embodiment, and will not be described in detail here, and normal electrification can also be realized. The user aligns the inner pot assembly 100, puts the alignment assembly (i.e. the handle) into the accommodation groove, without distinguishing between left and right, without deliberately aligning, the first coupler 102 and the second coupler 110 can be connected and powered up, improving the control experience.

Furthermore, in the above-mentioned specific embodiment, in the first coupler 102, the electrode needle A1121 and the electrode needle B1122 are respectively connected to the two poles of the heating element 128 (or the two poles of the sensor 204), and the electrode needle C1123 and the electrode needle D1124 are respectively connected to the two poles of the sensor 204 (or the two poles of the heating element 128).

In another specific embodiment, furthermore, when the first coupler 102 and the second coupler 110 are respectively provided with two electrodes, when the user puts the inner pot assembly 100 into the outer pot 106 in one direction, the accommodation groove limits the alignment assembly (i.e. the handle), the inner pot assembly 100 is moves down, the first coupler 102 contacts the second coupler 110, and the electrode needle 112 is inserted into the electrode groove 114. At this time, the electrode needle A1121 matches the electrode groove a1141 (or the electrode needle A1121 matches the electrode groove b1142), the electrode needle B1122 matches the electrode groove b1142 (or the electrode needle B1122 matches the electrode groove a1141), and the normal electrification is realized. The user aligns the inner pot assembly 100, puts the alignment assembly (i.e. the handle) into the accommodation groove, without distinguishing between left and right, without deliberately aligning, the first coupler 102 and the second coupler 110 can be connected and powered up, improving the control experience.

Furthermore, in the first coupler 102, the electrode needle A1121 and the electrode needle B1122 are respectively connected to the two poles of the heating element 128.

As shown in FIGS. 5 and 6, in any one of the above-mentioned embodiments, furthermore, a plurality of electrode needles 112 are distributed on the first circle, that is, a plurality of electrode needles 112 are distributed on the same circle, a plurality of electrode grooves 114 are distributed on the second circle, that is, a plurality of electrode grooves 114 are distributed on the same circle, and the diameters of the first circle and the second circle are equal. By setting the alignment assembly in the accommodation groove, the cooperation between the inner pot assembly 100 and the outer pot 106 can be limited. When the alignment assembly is located in the accommodation groove, the electrode needle 112 of the first coupler 102 on the inner pot assembly 100 and the electrode groove 114 of the second coupler 110 on the outer pot 106 can be in contact to achieve electrification. It further ensures that the inner pot 100 is normally placed in the outer pot 106 or rotated 180° and placed in the outer pot 106, that is, the first coupler 102 and the second coupler 110 can be connected and powered on without deliberate alignment, and the cooking device can work normally.

Or a plurality of electrode needles 112 is distributed on a plurality of first circles of different diameters. Since a plurality of electrode needles 112 exist in pairs, it is only necessary to ensure that each pair of electrode needles 112 is distributed on the same circle, the two electrode needles 112 existing in pairs do not need to be distinguished. A plurality of electrode grooves 104 is distributed on a plurality of second circles of different diameters. Since a plurality of electrode grooves 114 exist in pairs, it is only necessary to ensure that each pair of electrode grooves 114 is distributed on the same circle, the two electrode grooves 114 existing in pairs do not have to be distinguished. Furthermore, the diameters of a plurality of first circles are equal to the diameters of a plurality of second circles in one-to-one correspondence, and it is possible to limit the cooperation between the inner pot assembly 100 and the outer pot 106 by setting the alignment assembly in the accommodation groove. When the alignment assembly is located in the accommodation groove, the electrode needle 112 of the first coupler 102 on the inner pot assembly 100 and the electrode groove 114 of the second coupler 110 on the outer pot 106 can be in contact to achieve electrification. It further ensures that the inner pot assembly 100 is normally placed in the outer pot 106 or rotated 180° and placed in the outer pot 106, that is, the first coupler 102 and the second coupler 110 can be connected and powered on without deliberate alignment, and the cooking device can work normally.

As shown in FIGS. 5 and 6, in any one of the above-mentioned embodiments, furthermore, the first coupler 102 further comprises a first ground electrode 116, the first ground electrode 116 is located at a center of a distribution circle of the plurality of electrode needles 112; the second coupler 112 further comprises a second ground electrode 118, the second ground electrode 118 is located at a center of a distribution circle of the plurality of electrode grooves 114. By setting the first ground electrode 116 on the first coupler 102, setting the second ground electrode 118 on the second coupler 110, and setting the first ground electrode 116 at the center of the distribution circle of a plurality of electrode needles 112, the second ground electrode 118 is arranged at the center of the distribution circle of a plurality of electrode grooves 114. The first coupler 102 can make the first ground electrode 116 contact with the second ground electrode 118 no matter which direction the first coupler 112 is inserted into the second coupler 110. That is, by placing the handle 104 in the accommodation groove, the first ground electrode 116 and the second ground electrode 118 can be abutted without deliberate alignment, which further ensures that the first coupler 102 and the second coupler 110 are plugged into place, and by setting the first ground electrode 116 and the second ground electrode 118, can improve the safety of the use of the cooking device.

Furthermore, the first ground electrode 116 and the second ground electrode 118 may or may not be present.

Specifically, when the first coupler 102 and the second coupler 110 are set to five electrodes, that is, set the first ground electrode 116 and the second ground electrode 118; the electrode needle A1121 and the electrode needle B1122 are symmetrical with respect to the first ground electrode 116, the needle electrode C1123 and the electrode needle D1124 are symmetrical with respect to the first ground electrode 116, the electrode groove a1141 and the electrode groove b1142 are symmetrical with respect to the second ground electrode 118, and the electrode groove c1143 and the electrode groove d1144 are symmetrical with respect to second ground electrode 118. When the first coupler 102 and the second coupler 110 are set to four electrodes, that is, do not set the ground electrode; the electrode needle A1121 and the electrode needle B1122 are on the same circle, and are symmetrical with respect to the center of the circle, the needle electrode C1123 and the electrode needle D1124 are on the same circle, and are symmetrical with respect to the center of the circle, the electrode groove a1141 and the electrode groove b1142 are on the same circle and are symmetrical with respect to the center of the circle, the electrode groove c1143 and the electrode groove d1144 are on the same circle and are symmetrical with respect to the center of the circle.

### Embodiment 6

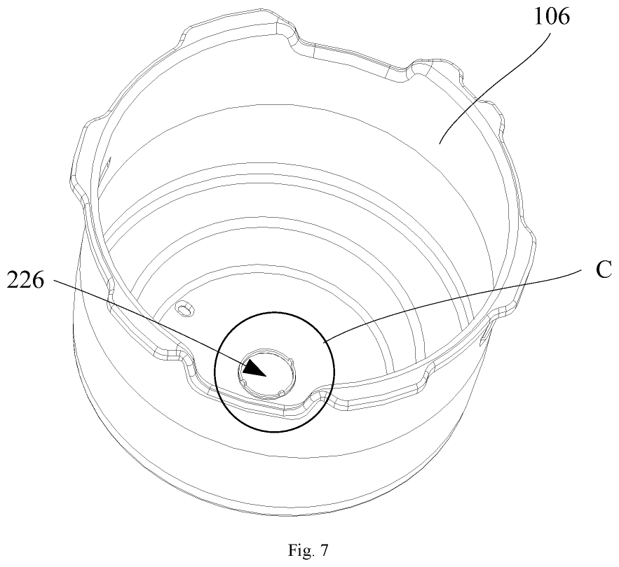

As shown in FIG. 7, in any one of the above-mentioned embodiments, furthermore, the cooking device further comprises: a mounting structure 228, being arranged at a bottom wall of the outer pot 106, the second coupler 110 being located at the mounting structure 228, the mounting structure 228 being configured to be adapted to support the second coupler 110.

In this embodiment, the outer pot 106 is provided with a mounting structure 228, the second coupler 110 is located at the mounting structure 228 and the mounting structure 228 can support the second coupler 110, which can limit, fix and support the assembly of the second coupler, which can ensure the installation position of the second coupler 110. Therefore, the assembly of the second coupler 110 is simple, and the first coupler 102 and the second coupler 110 are ensured to be plugged in place, the internal structure of the cooking device is arranged in an orderly manner, and there will be no structural interference, and avoid the downward displacement of the second coupler 110 when it is subjected to the impact force of the inner pot assembly 100 pressing downward.

Furthermore, the mounting structure 228 can be a one-piece structure formed integrally with the outer pot 106. The one-piece structure has good mechanical properties, so it can improve the connection strength between the outer pot 106 and the mounting structure 228. In addition, the outer pot 106 and the mounting structure 228 can be made into one piece and mass-produced to improve the processing efficiency of the product and reduce the processing cost of the product. And by designing the outer pot 106 and the mounting structure 228 into an integrated structure, the integrity of the cooking device is improved, the number of parts and components is reduced, the installation process is reduced, the installation efficiency is improved, and the installation of the cooking device is more convenient and reliable.

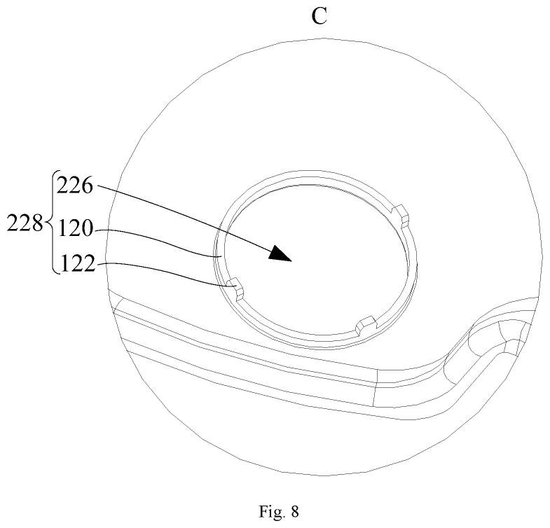

As shown in FIGS. 7 and 8, furthermore, the mounting structure 228 comprises a mounting hole 226, a rib 120, and a positioning boss 122. The bottom wall of the outer pot 106 is provided with a mounting hole 226, a rib 120 is arranged at the outer periphery of the mounting hole 226, the rib 120 is protrudingly arranged at the bottom wall of the outer pot 106, and the rib 120 can support the second coupler 110. Therefore, the second coupler 110 is fixed on the outer pot 106 through the rib 120, the rib 120 has a simple structure and is easy to produce, which can simplify the production process of the outer pot 106 and improve the production efficiency. Furthermore, the height of the rib 120 can be 0.5 mm to 5 mm, within this range, the height of the rib 120 is suitable, which is convenient for the processing and production of the rib 120 and the outer pot 106, and ensures that the rib 120 can support the installation of the second coupler 110.

In addition, the rib 120 is provided with a positioning boss 122, which can effectively prevent the second coupler 110 from rotating on the outer pot 106, and ensure the stable installation of the second coupler 110. Furthermore, the height of the positioning boss 122 can be 1 mm to 10 mm, within this range, the height of the positioning boss 122 is suitable, which is convenient for the processing and production of the positioning boss 122 and the outer pot 106, and improves the production efficiency.

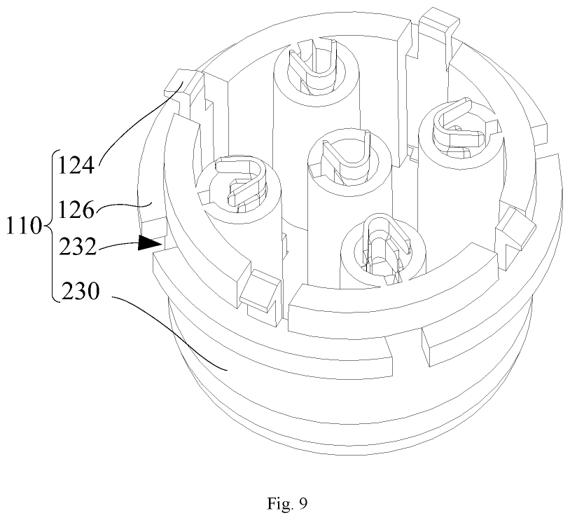

As shown in FIG. 9, in any one of the above-mentioned embodiments, furthermore, the second coupler 110 comprises a coupler housing 230, a buckle 124 and a support member 126, the buckle 124 is arranged at the coupler housing 230, and when the second coupler 110 is arranged, the buckle 124 passes through the mounting hole 226 arranged at the bottom wall of the outer pot 106 from the inside of the mounting cavity, and is buckled outside the bottom wall of the outer pot 106. That is, the second coupler 110 is arranged at the outer pot 106 from top to bottom, which facilitates the installation of the second coupler 110. Furthermore, a support member 126 is arranged at the outer periphery wall of the coupler housing 230, and the support member 126 abuts against the rib 120. That is, the rib 120 is located under the support member 126 to support the support member 126, and then the rib 120 is sandwiched between the support member 126 and the buckle 124 of the second coupler 110, the installation of the second coupler 110 is realized through the cooperation between the support member 126 and the buckle 124 and the rib 120.

In addition, the support member 126 is provided with a notch 232 extending through the support member 126 along the axial direction of the second coupler 110, and the rib 120 is provided with a positioning boss 122. When the second coupler 110 is assembled on the outer pot 106, the positioning boss 122 is located in the notch 232, which prevents the second coupler 110 from rotating on the outer pot 106, and ensures the stable installation of the second coupler 110. Furthermore, the height of the positioning boss 122 can be 1 mm to 10 mm, within this range, make sure that the positioning boss 122 has a sufficient height to be inserted into the notch 232, to cooperate with the notch 232 to limit the rotation of the second coupler 110.

Wherein, as shown in FIGS. 8 and 9, the numbers of the positioning boss 122 and the notch 232 are one-to-one correspondence, a plurality of positioning bosses 122 are arranged at the rib 120 at intervals, and a plurality of notches 232 are distributed on the support member 126 at intervals. That is, a plurality of positioning bosses 122 and a plurality of notches 232 can be set, and a plurality of positioning bosses 122 and a plurality of notches 232 are in one-to-one correspondence. That is, each of the positioning bosses 122 is inserted into one notch 232, and the cooperation of the plurality of positioning bosses 122 and the plurality of notches 232 can further prevent the second coupler 110 from rotating on the outer pot 106, and ensure the installation of the second coupler 110 is stable.

Furthermore, the height of the support member 126 can be 1 mm to 10 mm, within this range, the height of the support member 126 is suitable, which not only facilitates the processing and production of the support member 126 and the coupler housing 230, but also ensures that the support member 126 has sufficient strength, it can withstand the pressure of the inner pot assembly 100 on the second coupler 110 and is not easy to break and damage, it cooperates with the rib 120 to support the second coupler 110.

As shown in FIGS. 1 and 6, in any one of the above-mentioned embodiments, furthermore, the inner pot assembly comprises: an inner pot; a heating element 128, being arranged at a bottom wall of the inner pot; and a bottom cover 200, being arranged at a bottom of the inner pot, and connected with the inner pot, wherein, the bump 105 is arranged at the bottom cover 200, the bottom wall and the bottom cover 200 of the inner pot together form a sealed cavity, the heating element 128 is arranged in the sealed cavity, and electrically connected with the first coupler 102, and the first coupler 102 is located at least partially inside the sealed cavity.

In this embodiment, the bottom cover 200 is arranged at the bottom of the inner pot, the bottom wall and the bottom cover 200 of the inner pot are enclosed into a sealed cavity. The bump 105 is arranged at the bottom cover 200 to facilitate the processing of the bump 105, the heating element 128 is arranged in the sealed cavity, and the heating element 128 is electrically connected with the first coupler 102. During the use of the inner pot, the first coupler 102 is used in a way that cooperates with the second coupler 110 to supply power to the heating element 128, and the heating element 128 works to generate heat to cook the food in the cooking cavity. A part of the structure of the first coupler 102 is located in the sealed cavity, and the electrical components of the inner pot are also located in the sealed cavity.

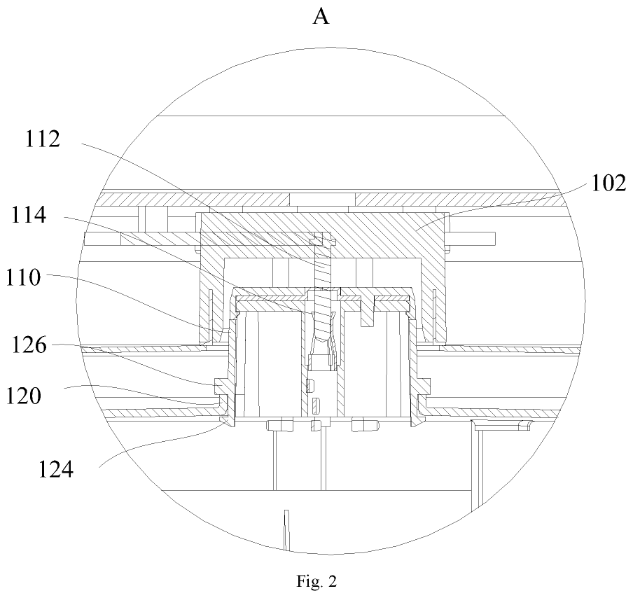

As shown in FIGS. 1 and 2, in any one of the above-mentioned embodiments, furthermore, a bottom plate 202 is arranged between the pot body and the heating element 128, and both the heating element 128 and the first coupler 102 are arranged at the bottom plate 202. On the one hand, the bottom plate 202 can prevent the heating element 128 and the first coupler 102 from being directly connected to the pot body, avoid the damage to the pot body caused by the connection process of the heating element 128 and the first coupler 102, and reduce the difficulty of connecting the heating element 128 and the first coupler 102. On the other hand, the bottom plate 202 can avoid the direct contact between the heating element 128 and the pot body, the heat generated by the heating element 128 is transferred to the pot body through the bottom plate 202, to ensure that the bottom of the pot body is evenly heated and the cooking effect is ensured.

Specifically, the pot body is made of stainless steel inner pot, and the bottom plate 202 is made of aluminum bottom plate. The bottom plate 202 is fixed on the pot body by welding or screws; the first coupler 102 is fixed on the bottom plate 202 by screws.

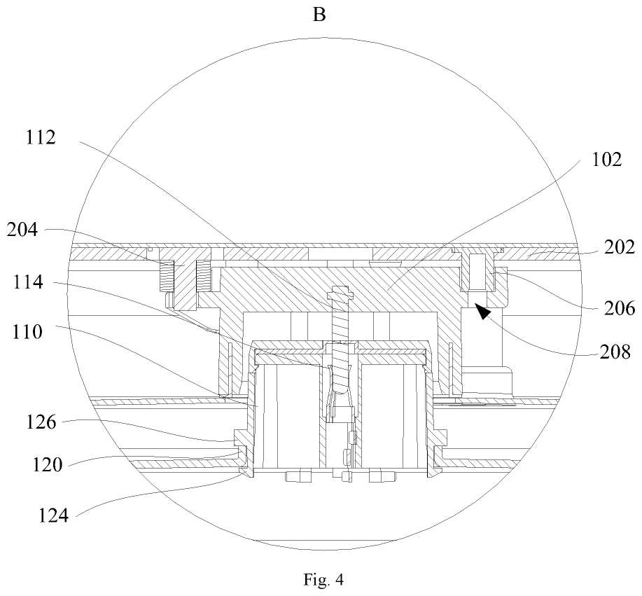

As shown in FIGS. 3 and 4, in any one of the above-mentioned embodiments, furthermore, the cooking device further comprises: a sensor 204, being arranged at the inner pot; and a pressure plate, being arranged at the first coupler 102, the pressure plate being configured to be adapted to fix the sensor 204.

In this embodiment, the sensor 204 is arranged at the inner pot, the pressure plate is arranged at the first coupler 102, and is configured to be adapted to fix sensor 204. Specifically, the sensor 204 can be a temperature sensor, and pressure is applied to the sensor 204 through a pressure plate, the sensor 204 and the inner pot assembly 100 fit together, which can ensure that the sensor 204 and the inner pot assembly 100 are in firm contact and fit tightly. This ensures that the temperature of the medium inside the inner pot assembly 100 can be quickly and accurately transferred to the sensor 204; the sensor 204 can accurately measure the temperature and improve the performance of the product.

As shown in FIGS. 3 and 4, in any one of the above-mentioned embodiments, furthermore, the bottom plate 202 is provided with a fixation column 206 extending downward from the bottom wall of the bottom plate 202. The first coupler 102 is provided with a fixation hole 208, the fixation column 206 is inserted into the fixation hole 208, and the connection member is connected to the fixation column 206 through the fixation hole 208. Therefore, the first coupler 102 is fixed on the bottom plate 202 through the connection member, which can not only make the connection between the first coupler 102 and the bottom plate 202 firm, but also facilitate the installation and disassembly of the first coupler 102.

Specifically, the connection member can be a screw, and the screw connection is convenient for installation, which saves costs, simplifies the production process, improves production efficiency, and facilitates subsequent disassembly and maintenance.

In the description of the present disclosure, the term “plurality” refers to two or more, unless expressly limited otherwise, the orientation or position relationships indicated by the terms “upper,” “lower” and the like are the orientation or position relationships based on what is shown in the drawings, are merely for the convenience of describing the present disclosure and simplifying the description, and do not indicate or imply that the device or element referred to must have a particular orientation and is constructed and operated in a specific orientation, and thus cannot be understood as the limitation of the present disclosure. The terms “connection,” “mounting,” “fixing” and the like should be understood in a broad sense. For example, “connection” may be a fixed connection, a removable connection or an integral connection; and may refer to direct connection and may also refer to indirect connection through an intermediary. A person of ordinary skills in the art could understand the specific meaning of the terms in the present disclosure according to specific situations.

In the description of the present specification, the descriptions of the terms “one embodiment,” “some embodiments” and “specific embodiments” and the like mean that specific features, structures, materials or characteristics described in conjunction with the embodiment(s) or example(s) are comprised in at least one embodiment or example of the present disclosure. In the specification, the schematic representation of the above terms does not necessarily refer to the same embodiment or example. Moreover, the particular features, structures, materials or characteristics described may be combined in a suitable manner in any one or more embodiments or examples.

The descriptions above are only preferred embodiments of the present disclosure, which are not used to limit the present disclosure. For a person skilled in the art, the present disclosure may have various changes and variations. Any modifications, equivalent substitutions, improvements etc. within the spirit and principle of the present disclosure shall all be comprised in the protection scope of the present disclosure.

1.-19. (canceled)

20. A cooking device comprising:
an outer pot having a mounting cavity;
an inner pot assembly removably arranged in the mounting cavity;
a first coupler arranged at the inner pot assembly;
an accommodation groove arranged at one of the inner pot assembly and the outer pot;
an alignment assembly arranged at another one of the inner pot assembly and the outer pot, and configured to be arranged in the accommodation groove; and
a second coupler arranged at the outer pot and configured to be plugged with the first coupler.

21. The cooking device according to claim 20, wherein
the alignment assembly includes a handle; and
the accommodation groove includes a groove formed by a downward depression of an upper surface of the outer pot, the groove matching the handle.

22. The cooking device according to claim 21, wherein:
the groove is a first groove;
the alignment assembly further includes a bump arranged at one of a bottom of the inner pot assembly and a bottom wall of the mounting cavity; and
the accommodation groove further includes a second groove arranged at another one of the bottom of the inner pot assembly and the bottom wall of the mounting cavity.

23. The cooking device according to claim 21, wherein a distance between a groove wall of the groove and an edge of the handle ranges from 0.2 mm to 6 mm.

24. The cooking device according to claim 20, wherein:
the alignment assembly includes a bump arranged at a bottom of the inner pot assembly; and
the accommodation groove includes a groove arranged at a bottom wall of the mounting cavity, the groove matching the bump.

25. The cooking device according to claim 24, wherein:
a bottom wall of the outer pot includes a stepped surface on an outer peripheral side and a sinking step in a middle portion, and a side wall of the sinking step is recessed to form the second groove;
a shape of a bottom wall of the inner pot assembly matches a shape of the bottom wall of the outer pot, to allow the inner pot assembly to be embedded in the outer pot; and
a maximum distance between the bump and a center of the inner pot assembly is greater than a radius of the stepped surface, to allow the bump to be supported on the stepped surface.

26. The cooking device according to claim 24, wherein a radial clearance between the bump and the groove when the bump is located in the groove is greater than or equal to 0.1 mm and less than or equal to 2 mm.

27. The cooking device according to claim 20, wherein:
the alignment assembly includes two handles symmetrically arranged at two sides of the inner pot assembly; or
the alignment assembly includes two bumps is two distributed symmetrically about a central axis of the inner pot assembly.

28. The cooking device according to claim 20, wherein:
one of the first coupler and the second coupler includes a plurality of electrode needles, and another one of the first coupler and the second coupler includes a plurality of electrode grooves;
the plurality of electrode needles are configured to be inserted in the plurality of electrode grooves for electrical connection when the alignment assembly is located in the accommodation groove.

29. The cooking device according to claim 28, wherein:
the plurality of the electrode needles include a pair of electrode needles distributed on a first circle and distributed symmetrically about a center of the first circle;
the plurality of electrode grooves include a pair of electrode grooves distributed on a second circle and distributed symmetrically about a center of the second circle; and
the plurality of electrode needles correspond to the plurality of electrode grooves in a one-to-one correspondence.

30. The cooking device according to claim 29, wherein a diameter of the first circle equals a diameter of the second circle.

31. The cooking device according to claim 28, wherein
the plurality of electrode needles are distributed on a plurality of first concentric circles with different diameters;
the plurality of electrode grooves are distributed on a plurality of second concentric circles with different diameters; and
the diameter of each of the plurality of first concentric circles equals the diameter of a corresponding one of the plurality of second concentric circles.

32. The cooking device according to claim 28, wherein:
the first coupler further includes a first ground electrode located at a center of a distribution circle of the plurality of electrode needles;
the second coupler further includes a second ground electrode located at a center of a distribution circle of the plurality of electrode grooves; and
the first ground electrode and the second ground electrode are configured to abut against each other when the first coupler is plugged with the second coupler.

33. The cooking device according to claim 20, wherein a distance between a side wall of the inner pot assembly and an inner side wall of the mounting cavity ranges from 0.1 mm to 6 mm.

34. The cooking device according to claim 20, further comprising:
a mounting structure arranged at a bottom wall of the outer pot;
wherein:
the second coupler is located at the mounting structure, and the mounting structure is configured to support the second coupler; and
the mounting structure includes:
a mounting hole arranged at the bottom wall of the outer pot;
a rib arranged at an outer periphery of the mounting hole, the rib being protrudingly arranged at a bottom wall of the outer pot, and the rib supporting the second coupler; and
a positioning boss protrudingly arranged at the rib.

35. The cooking device according to claim 34, wherein the second coupler includes:
a coupler housing;
a buckle arranged at the coupler housing and configured to pass through the mounting hole to be buckled on an outside of the bottom wall of the outer pot; and
a support member arranged at an outer periphery wall of the coupler housing and abutting against the rib, a notch extending through the support member along an axial direction of the second coupler being arranged at the support member, and the positioning boss being located in the notch.

36. The cooking device according to claim 20, wherein the inner pot assembly includes:
an inner pot;
a bottom cover arranged at a bottom of the inner pot, and connected with a bottom wall of the inner pot to form a sealed cavity, the first coupler being at least partially located inside the sealed cavity; and
a heating element arranged at the bottom wall of the inner pot and in the sealed cavity, and electrically connected to the first coupler.

37. The cooking device according to claim 36, wherein the inner pot includes:
a pot body; and
a bottom plate arranged between the pot body and the heating element, and connected to the heating element and the first coupler.

38. The cooking device according to claim 37, further comprising:
a fixation hole arranged at the first coupler;
a fixation column arranged at the bottom plate and extending downward from a bottom wall of the bottom plate to be inserted in the fixation hole; and
a connection member passing through the fixation hole to be connected to the fixation column, to connect the first coupler and the bottom plate.

39. The cooking device according to claim 36, further comprising:
a sensor arranged at the inner pot; and
a pressure plate arranged at the first coupler and configured to fix the sensor.
